(19) United States
(12) Patent Application Publication
(10) Pub. No.: US 2013/0189726 A1
(43) Pub. Date: Jul. 25, 2013

(54) METHOD FOR PREPARING AND/OR PROCESSING A BIOLOGICAL SAMPLE USING A MALODOUR COUNTERACTANT

(71) Applicants: Margit Hiesinger, Hilden (DE); Markus Mueller, Hilden (DE)

(72) Inventors: Margit Hiesinger, Hilden (DE); Markus Mueller, Hilden (DE)

(73) Assignee: QIAGEN GmbH, Hilden (DE)

(21) Appl. No.: 13/825,537

(22) PCT Filed: Sep. 26, 2011
(86) PCT No.: PCT/EP2011/066696

§ 371 Date: Mar. 21, 2013

(30) Foreign Application Priority Data
Sep. 24, 2010 (EP) 10010524.6

(51) Int. Cl. G01N 1/34

(52) U.S. Cl. CPC G01N 1/34
USPC 435/29; 422/549; 422/552; 422/556; 422/527; 422/524; 435/289.1; 436/175

(57) ABSTRACT

The present invention pertains to a biotechnological method for preparing and/or processing a biological sample, in particular for isolating at least one target biomolecule therefrom, which characterised in that at least one malodour counteractant is used for preventing, reducing, masking and/or suppressing malodour and/or malodour formation during the preparation and/or processing of said biological sample.

The present invention pertains to the field of biotechnology for preparing and/or processing a sample, in particular for isolating biomolecules such as nucleic acids from a biological sample.

### BACKGROUND OF THE INVENTION

Many types of starting materials that are used for the preparation of nucleic acids, proteins or other target molecules have a malodorous smell or develop one during their preparation and/or processing. Furthermore, during the preparation and/or processing of a biological sample, chemicals are often used which contribute to the malodorous smell.

This malodour is a nuisance for the people working with the respective samples and/or chemicals such as lab technicians, in particular when preparing and/or processing a large number of samples or large volume samples.

Therefore, it is an object to provide improved methods for preparing and/or processing a biological sample, in particular for isolating nucleic acids, proteins or other target molecules, which reduces the burden imposed by malodour formation during preparation and/or processing of the sample in the field of biotechnology.

### SUMMARY OF THE INVENTION

The present invention is based on the finding that a malodour counteractant can be used for preventing, reducing, masking and/or suppressing malodour during the preparation and/or processing of a biological sample. The sample itself may have and/or may develop strong smelling properties during its preparation and/or processing (such as for example E. coli cultures, stool or urine samples) and/or substances might be present during the preparation/processing of the sample which have malodorous properties, such as for example beta-mercaptoethanol or phenol. The use of at least one malodour counteractant according to the present invention neutralizes, reduces, suppresses, compensates, deodorises and/or masks the malodour which is present and/or which develops during the preparation and/or processing of the sample. It was surprisingly found that by choosing the right malodour counteractant it can be used without negatively affecting the preparation and/or processing of a biological sample, for example when isolating nucleic acids therefrom. These advantages are achieved by choosing the appropriate malodour counteractant for the biological sample to be processed and/or prepared. Furthermore, it is also important to chose the appropriate packaging, respectively presentation form of the malodour counteractant in order to prevent that it interferes with the preparation and/or processing of the biological sample and in particular to prevent that the sample is contaminated with the malodour counteractant. The present invention describes the general concept of the invention, as well as particularly suitable combinations of biological samples and malodour counteractants for counteracting, preventing, suppressing, reducing and/or masking malodour which is present and/or which develops during the preparation and/or processing of the biological sample.

According to a first aspect, the present invention pertains to a method for preparing and/or processing a biological sample, which is characterized in that at least one malodour counteractant is used for preventing, reducing, masking and/or suppressing malodour and/or malodour formation during the preparation and/or processing of said biological sample.

According to a second aspect, the present invention pertains to the use of at least one malodour counteractant for preventing, reducing, masking and/or suppressing malodour and/or malodour formation during the preparation and/or processing of a biological sample.

According to a third aspect, the present invention pertains to a laboratory vessel for harbouring a biological sample, wherein said vessel comprises at least one malodour counteractant.

Other objects, features, advantages and aspects of the present application will become apparent to those skilled in the art from the following description and appended claims. It should be understood, however, that the following description, appended claims, and specific examples, while indicating preferred embodiments of the application, are given by way of illustration only. Various changes and modifications within the spirit and scope of the disclosed invention will become readily apparent to those skilled in the art from reading the following.

### DETAILED DESCRIPTION OF THE INVENTION

The present invention is based on the finding that a malodour counteractant can be advantageously used to prevent, reduce, suppress, counteract and/or mask malodour, respectively malodour formation during the preparation and/or processing of a biological sample in the field of biotechnology, in particular when the biological sample is cultured and/or processed for isolating biological target molecules therefrom, e.g. nucleic acids, proteins and/or other biomolecules such as lipids. By choosing a malodour counteractant which does not interfere with the intended preparation and/or processing of the biological sample, a novel concept is provided, which has the advantage that people preparing and/or processing biological samples such as lab technicians are not burdened by malodour, respectively the development of malodour. As discussed above, malodour or malodour formation during the processing and/or preparation of biological samples is a considerable burden for the people working with respective samples, in particular when the work comprises the processing and/or preparation of a large number of respective samples as is e.g. the case with lab technicians. Therefore, the concept of the present invention which teaches to use a malodour counteractant during the preparation and/or processing of a biological sample provides a novel approach because malodour counteractants were so far not used for that purpose. Furthermore, the inventors have found that the choice of the right malodour counteractant for the respectively concerned sample is important in order to avoid that the malodour counteractant negatively interferes with the intended preparation and/or processing of the biological sample. Furthermore, it was found that not any fragrance will counteract the malodour of any biological sample e.g. by masking the malodour, some even increase the malodorous smell. Thus, the choice of the suitable malodour counteractant respectively the matching of the malodour counteractant with the respective sample is important.

Many types of starting materials such as biological samples that are used for the isolation of nucleic acids, proteins or other target molecules have and/or develop an unpleasant, malodorous smell during their preparation and/or processing. Moreover, during the preparation and/or processing of a respective sample, in particular when isolating nucleic acids, proteins and/or other target molecules involve the use of chemicals which have an unpleasant smell and which accordingly are malodorous. Furthermore, malodorous substances can also develop during the processing and/or preparation, e.g. due to chemical reactions. This unpleasant, malodorous smell is masked, eliminated, suppressed and/or at least reduced by the use of the malodour counteractant according to the present invention.

Thus, in a first aspect, a method for preparing and/or processing a biological sample is provided, characterised in that at least one malodour counteractant is used for preventing, reducing, masking and/or suppressing malodour and/or malodour formation during the preparation and/or processing of said biological sample.

Biological samples which can be used in the method according to the present invention include but are not limited to eukaryotic cells, prokaryotic cells, cell cultures, bacteria cell cultures, viral particles, microorganisms, stool, feces, blood, body fluids, clinical samples, urine, swabs, tissue and samples derived there from as well as any samples which have or may develop a malodour during their preparation and/or processing.

According to one embodiment, the sample has or develops during its processing and/or preparation—e.g. during its cultivation or lysis—a malodour. One example for a respective sample includes bacterial cultures such as E. coli cultures, which develop a strong malodorous smell during their growth and also during their preparation, e.g. during lysis and/or when isolating nucleic acids or other biolmolecules therefrom.

According to one embodiment, the malodour and/or the malodour formation during the preparation and/or processing of the biological sample (in particular during a nucleic acid or protein isolation procedure) is at least partially attributable to the use of at least one substance which has or develops an unpleasant smell during its use. A respective substance can be comprised for example in the chemistry that is used for preparing and/or processing the biological sample, for example in the chemistry used for isolating biomolecules such as nucleic acids or proteins from said sample. Furthermore, malodours substances might also be produced during the preparation and/or processing, e.g. due to chemical reactions of the used chemistry with the sample. Examples of respective malodorous substances which have or develop a malodour during the preparation and/or processing of a biological sample include but are not limited to mercaptanes such as beta mercapthoethanol, malodorous heterocyclic aromatic amines, malodorous heterocyclic amines, malodorous heterocyclic aliphatic amines, malodorous primary aliphatic diamines, malodorous carboxylic acids and salts and esters thereof such as butyric acid, acetic acid, formic acid and acetates, malodorous fatty acids, malodorous alcohols, ethanol, phenol, dithiotreitole (DTT), isopropanol and other alcohols.

There are several possibilities to include and use the malodour counteractant during the preparation and/or processing of the biological sample.

The malodour counteractant can, e.g., be added at the time of the inoculation of a cell culture such as e.g. a bacterial cell culture, during it's growth, prior to or during harvesting of the cells, prior to the preparation and/or at other steps of the preparation of the sample material and/or processing of the sample, in particular when isolating biomolecules such as nucleic acids from said biomolecule culture, wherein there is a risk of malodour formation. The malodour counteractant can also be added prior to storage of the starting material, which is usually a biological sample.

As malodour counteractant, one or more substances can be used which either alone or in combination act as malodour counteractant. Thus, as malodour counteractant any substance(s) or composition(s) may be used which is capable of counteracting the malodour and accordingly can prevent, suppress, reduce, mask or eliminate the malodour or the malodour formation. According to one embodiment, the malodour counteractant is a fragrance and any suitable fragrance may be used which does not interfere with the intended preparation and/or processing of the biological sample or subsequent use. A fragrance usually predominantly counteracts the malodour by masking the malodour with a pleasant odour. However, the malodour counteractant can also be a chemical substance or material with no pleasant odour of its own, but can be one that e.g. interacts with the malodour causing substance, thereby removing and/or reducing the malodour and/or the malodour formation.

According to one embodiment, a composition is used which comprises or consists of a malodour counteractant. As discussed above, also a mixture of substances respectively compounds can be used as malodour counteractant. Preferably, a composition is used which consists of or comprises
at least one fragrance which predominantly masks, respectively covers the malodour and/or
at least one chemical substance or material which interacts with the malodour causing substance or their precursors, thereby at least reducing the malodour and/or the malodour formation.

Preferably, the malodour counteractant is capable of evaporation or of being dispersed into the environmental air and counteracting the malodour (see above, e.g. by preventing, masking, reducing, suppressing the malodour or the malodour formation) that is present and/or is developed during the preparation and/or processing of the biological sample. As discussed above, the biological sample itself may have or may develop a malodour during its preparation and/or processing. Furthermore, the malodour formation may be due to the use or presence of one or more chemical substances which have an unpleasant, malodorous smell by themselves such as for example phenol or beta-mercaptoethanol.

As discussed above, it is important that the malodour counteractant does not interfere with the intended preparation/processing of the biological sample and in particular does not interfere with the intended isolation procedure, when isolating a biological target molecule. Therefore, according to one embodiment, no organism is used as malodour counteractant. According to said embodiment, in particular, no spore-forming bacteria is used as malodour-counteractant. Avoiding malodour counteractants that are organisms such as specific bacteria has the advantage that the biological sample will not be contaminated during its preparation and/or processing with biomolecules derived from said organism that is used as malodour counteractant. Therefore, according to one embodiment, a chemical compound respectively a mixture of chemical compounds is used as malodour counteractant. Suitable examples are described below which can, if combined with the right sample, suppress the malodour formation without interfering with the preparation and/or processing of the sample.

Suitable fragrances that can be used as malodour counteractant include fragrances selected from such classes as acids, esters, alcohols, aldehydes, ketones, lactones, nitriles, ethers, acetates, hydrocarbons, sulfur- nitrogen- and oxygen-containing heterocyclic, polycyclic and macrocyclic compounds, as well essential oils of natural or synthetic origin. Such fragrance materials are described, for example, in S. Arctander, Perfume Flavors and Chemicals Vols. 1 and 2, Arctander, Montclair, N.J. USA 1969. The fragrance optionally may comprise odourless liquids such as benzyl benzoate, isopropylmyristate, and hydrocarbon derivatives, such as for example Isopar from Exxon or glycol ethers from Dow Chemical. Also mixtures of respective compounds can be used.

According to one embodiment, suitable malodour counteractants include fragrance compounds, for example synthetic products of the ester, ether, aldehyde, ketone, alcohol and hydrocarbon type. Fragrance compounds of the ester type are, for example, benzyl acetate, phenoxyethyl isobutyrate, p-tertbutyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxy-acetaldehyde, cyclamen aldehyde, hydroxycitronellal, lilial and bourgeonal; the ketones include, for example, the ionones, [alpha]-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, also mixtures of various fragrances which together produce an attractive fragrance note can be used as malodour counteractant. Fragrance oils may also be used and may contain natural fragrance mixtures.

According to one embodiment, a fragrance alcohol is used as malodour counteractant. As used herein, the term “fragrance alcohol” in particular refers to any compound or mixture of compounds of formula R′—OH, known to be a fragrance, respectively perfume, wherein R′ is the residual of an aroma chemical or fragrance component, that is capable of being physically or covalently bound to the hydrophobic delivery vehicle, irrespective of the further structure of the fragrance compound. Non-limiting examples of fragrance alcohols may be found in Steffan Arctander, “Perfume and Flavor Chemicals (Aroma Chemicals)”, Volumes 1 and 2, (1969); Bauer, K. et al., “Common Fragrance and Flavor Materials”, Wiley-VCH Publishers (1997); Guenther Ohloff, “Scent and Fragrances”, Springer-Verlag Publishers (1994); and “Perfumes: Art, Science, and Technology”, Mueller, P. M. I and Lamparsky, D, editors, Blackie Academic and Professional Publishers (1994), the disclosures of which are each hereby incorporated herein by reference, in their entireties. Preferred fragrance alcohols include 10-undecen-1-ol, 2,6-dimethylheptan-2-ol, 2-methylbutanol, 2-methylpentanol, 2-phenoxyethanol, 2-phenylpropanol, 2-tert-butyl-cyclohexanol, 3,5,5-trimethylcyclohexanol, 3-hexanol, 3-methyl-5-phenyl pentanol, 3-octanol, 3-phenylpropanol, 4-heptenol, 4-isopropyl cyclohexanol, 4-tert-butyl cyclohexanol, 6,8-dimethyl-2-nonanol, 6-nonen-1-ol, 9-decen-1-ol, alpha-methyl benzyl alcohol, alpha-terpineol, amyl salicylate, benzyl alcohol, benzyl salicylate, beta-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-methan-7-ol, phenethyl alcohol, phenyl salicylate, tetrahydrogeraniol, tetrahydrolinalool, thymol, trans-2-m-6-nonadienol, trans-2-nonen-1-ol, (S)-2-octenol, undecanol, vanillin, tetrahydromyrcenol, the various natural and synthetic sandalwood alcohols, trans-2-hexen-1-ol, cis-2-hexen-1-ol, 1-octen-3-ol, and cinnamyl alcohol. Also suitable are the corresponding fragrance aldehydes. Also mixtures of respective compounds can be used.

According to one embodiment, a highly volatile fragrance is used as malodour counteractant. Examples of the highly volatile fragrances include, but are not limited to, anethole, benzaldehyde, benzyl acetate, benzyl alcohol, benzyl formate, iso-bornyl acetate, camphene, cis-citral (neral), citronellal, citronellol, citronellyl acetate, paracymene, decanal, dihydrolinalool, dihydromyrcenol, dimethyl phenyl carbinol, eucalyptol, geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone, myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, and vertenex (para-tertiary-butyl cyclohexyl acetate). Also mixtures of respective compounds can be used. Also suitable are the corresponding fragrance aldehydes.

According to one embodiment, a moderately volatile fragrance is used as malodour counteractant. Examples of moderately volatile fragrances include, but are not limited to, amyl cinnamic aldehyde, iso-amyl salicylate, beta-caryophyllene, cedrene, cinnamic alcohol, coumarin, dimethyl benzyl carbinyl acetate, ethyl vanillin, eugenol, iso-eugenol, floracetate, heliotropine, 3-cis-hexenyl salicylate, hexyl salicylate, filial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, and veratraldehyde. Cedarwood terpenes are composed mainly of alpha-cedrene, beta-cedrene, and other C₁₅H₂₄ sesquiterpenes. Also mixtures of respective compounds can be used.

According to one embodiment, a less volatile fragrance is used as malodour counteractant. Examples of the less volatile fragrances include, but are not limited to, benzophenone, benzyl salicylate, ethylene brassylate, galaxolide (1,3,4,6,7,8-hexahydro-4,6,6,7,8,8-hexamethyl-cyclopenta-gama-2-benzopyran), hexylcinnamic aldehyde, lyral (4-(4-hydroxy-4-methyl pentyl)-3-cyclohexene-10-carboxaldehyde), methyl cedrylone, methyl dihydro jasmonate, methyl-beta-naphthyl ketone, musk indanone, musk ketone, musk tibetene, and phenylethyl phenyl acetate. Also mixtures of respective compounds can be used.

According to one embodiment, the fragrance is selected from the group consisting of alpha-isomethylionone, amyl cinnamal, amylcinnamyl alcohol, anise alcohol, benzyl alcohol, benzyl benzoate, benzyl cinnamate, benzyl salicylate, butylphenyl methylpropional, cinnamal, cinnamyl alcohol, citral, including citral A and citral B, citronellol, coumarin, dipentene, eugenoll, farnesol, geraniol, hexyl cinnamal, hydroxycitronellal, hydroxyisohexyl 3-cyclohexene, carboxaldehyde, isoeugenol, limonene, linalool, methyl 2-octynoate. Also mixtures of respective compounds can be used.

According to one embodiment, the malodour counteractant is selected from the group consisting of benzyl salicylate, citral, including citral A and citral B, citronellol, Coumarin, geraniol, limonene, linalool, eucalyptol, hydroxycitronellal and trans-menthol. According to one embodiment, a mixture of coumarin, citronellol, linalool, benzyl salicylate is used,

According to one embodiment, the fragrance has a citrus and/or lime smell. A respective malodour counteractant is particularly suitable when processing and/or preparing bacteria such as E. coli, e.g. during their growth and the isolation of nucleic acids therefrom. According to one embodiment, a fragrance is used which is commonly used in dishwasher deodorants such as e.g. the “Calgonit finish” deodorant (commercially available product—citrus and lime smell) which is also preferred to counteract the malodour formed by bacterial cells such as E. coli cells.

According to one embodiment, at least one fragrance is used that is selected from the group consisting of linalool, limonene, dipentene, citral, citronellol and citronellal, preferably limonene and citral. Also mixtures of respective compounds can be used.

According to one embodiment, at least one fragrance is used that is selected from the group consisting of citrathal, terpineole and citral.

The fragrance is preferably used in a concentration wherein it develops a pleasant smell when used during preparation and/or processing of the sample.

According to one embodiment the malodour counteractant and/or the composition consisting of or comprising the malodour counteractant is not in physical contact with the sample. This reduces the risk that the biological sample is contaminated with the malodour counteractant and/or the composition and accordingly, the risk is reduced that the malodour counteractant and/or the composition consisting of or comprising the malodour counteractant interferes with the intended preparation and/or processing of the sample, such as for example a nucleic acid isolation procedure.

According to a further embodiment, the malodour counteractant and/or the composition consisting of or comprising the malodour counteractant is in physical contact with the sample. This embodiment is suitable for applications, wherein the malodour counteractant and/or the composition consisting of or comprising the malodour counteractant does not interfere with the intended preparation and/or processing of the biological sample. E.g. the malodour counteractant, which can also be a mixture of compounds (see above) can be provided on a carrier such as e.g. a filter or membrane which is added to the sample during preparation and/or processing.

According to one embodiment, the composition consisting of or comprising the malodour counteractant which is preferably a fragrance is comprised within a container. This has the advantage that the malodour counteractant and/or the composition consisting of or comprising the malodour counteractant is easy to handle and is also kept separate from the biological sample.

According to one embodiment, the malodour counteractant is gradually releasable, that is, it is kept within the container in such a manner that it will be released over a prolonged time period. This can be achieved in any suitable manner, and the skilled person will readily be able to realise many suitable means of achieving this. Examples include absorption on or in a solid porous substance or any other matrix suitable for evaporating respectively releasing the malodour counteractant, incorporation into a gel and retention behind a membrane or device adapted to permit slow passage of the malodour counteractant and/or the composition comprising the malodour counteractant and evaporation at the surface thereof. This has the advantage that the development of malodour is efficiently suppressed/masked for a prolonged period of time during the preparation and/or processing of the biological sample. The gradual release can be achieved by any suitable manner and the skilled person will readily be able to realise many suitable means of achieving this.

According to one embodiment, the container comprises at least one port through which the malodour counteractant may be released. The port to which the malodour counteractant is released may be any suitable opening and the container may also comprise more than one port.

According to one embodiment, the container comprises a port for release of the malodour counteractant, the extent of opening of the port being controllable and wherein the fragrance and/or the composition consisting of or comprising the fragrance is preferably contained in a device such as a blister disposed in the container. The blister can be made out of a porous membrane as is described below.

According to one embodiment, the malodour counteractant and/or the composition consisting of or comprising the malodour counteractant is contained within a cartridge as container. A cartridge has the advantage that it is replaceable and therefore, can be exchanged in case one cartridge is used up and has released the malodour counteractant.

According to one embodiment, the composition consisting of or comprising the malodour counteractant is contained within a device which is at least permeable for the malodour counteractant. Preferably, said device is a membrane. According to one embodiment, the membrane is porous. The membrane may be a non-water soluble membrane. According to one embodiment, the membrane has the thickness of less than 500 μm, more preferably less than 200 μm, more preferably less than 120 μm. According to one embodiment, the membrane has a thickness of between 15 and 100 μm. According to one embodiment, the membrane has a pore size which allows the diffusion and/or passage of molecules smaller than 5 kD, preferably smaller than 2 kD and even more preferred smaller than 500 Da.

According to one embodiment, a non-water soluble membrane is used. Said membrane may comprise a polymer selected from the group of polyurethanes, poly-ether-amides, polyethylene-acrylic acid copolymers, polyethylene oxides, poly lactic acids, polyamides, polyesters, sulfonated polyesters, poly-ether-ester block copolymers, polyacrylates, polyacrylic acids, polyethylene-vinyl acetate polyvinyl alcohols, polyvinyl ethers, poly-2-ethyl-oxazolines, polyvinyl pyrrolidones, cellulose derivates, co-polymers and mixtures thereof.

The membrane may also comprise filling and/or reinforcement materials. Any suitable membrane that is also used in for example dishwasher deodorants or similar products using fragrances can be used for this purpose. This embodiment is particularly suitable when processing and/or preparing bacteria.

According to one embodiment, the container comprising the malodour counteractant and/or the composition consisting of or comprising the malodour counteractant is positioned inside a vessel which harbours the sample. Examples of respective vessels include but are not limited to sample storage or sample processing vessels, reaction and collection vessels, Eppendorf tubes, multi-well plates, deepwell blocks, flasks, Erlenmeyer flasks, spin columns, filter tips and dispenser tips, pipette tips, tubes, phioles, test tubes, beakers, tumblers, measuring cups, graduated cylinders, centrifuge bottles and disposable plastic containers

The container comprising the malodour counteractant may be fixed to the respective vessel or may be mounted, for example clipped to the respective vessel. Furthermore, an adhesive can be used to attach e.g. a paper strip or another solid matrix which releases the malodour counteractant to the vessel wall. E.g. a label comprising the malodour counteractant, which can also be provided by a mixture of compounds (see above), can be attached to the vessel, e.g. at the inside or the outside. Preferably, it is attached to the exterior surface of the vessel. The label is adapted to release the malodour counteractant. E.g. the malodour counteractant can be added to the label during the production e.g. extrusion of the label. Suitable means for providing a label with a malodour counteractant as described herein are known to the skilled person and thus, do not need a detailed description here. Furthermore, the vessel may comprise a receptacle into which the container can be inserted. As discussed above, the container may be a cartridge which can accordingly be removed and thus replaced from the receptacle of the vessel, as soon as the malodour counteractant is used up. This allows to re-use the vessel that is specifically adapted for the use in the method according to present invention by inserting a new container comprising a malodour counteractant. The present invention refers to respective re-usable vessels as well as vessels which are made for single use only.

According to one embodiment, the container is suited for submersion in the sample. In this embodiment, the container is contacted to the sample. The respective container can be for example magnetic in order to allow the easy removal of the container from the sample.

The composition comprising the malodour counteractant may comprise further additives for formulating the malodour counteractant for example in form of gel or a paste. Suitable additives are known in the prior art for example from the preparation of dishwasher deodorants or other malodour counteractants such as fragrances that are used in other cleaning agents, toilet cleaners, toilet blocks or bleach blocks. As discussed above, the composition comprising the malodour counteractant preferably has a composition that does not interfere with the intended preparation and/or processing of the biological sample or subsequent use. Whether there is a risk of respective interference depends on the processed sample, the used malodour counteractant, the composition that is used for formulating the malodour counteractant, the housing/container of the malodour conteractant and whether the malodour counteractant respectively the composition is in direct contact with the sample or, as it is described as preferred above, is not in physical contact with the sample. As described above, the use of the malodour counteractant without physical contact of the sample can be achieved for example by positioning the malodour counteractant respectively the composition comprising said malodour conteractant in a container within a vessel that harbours or is supposed to harbour a biological sample, without bringing said container into physical contact with the sample. As described above, the vessel may for example comprise a receptacle for receiving the container or cartridge comprising the malodour counteractant and/or the composition. The receptacle, however, may also directly receive the malodour counteractant or the composition comprising the malodour counteractant. Preferably, said receptacle is positioned such that the malodour counteractant respectively the composition comprising or consisting of the malodour counteractant is not in physical contact with the sample when said sample is contained and/or processed in the vessel. Thereby, it can be securely prevented that the sample is in direct contact with the malodour counteractant, respectively the composition consisting of or comprising the malodour counteractant.

According to one embodiment, the malodour counteractant is directly added to the chemicals that are used for processing and/or preparing the biological samples, such as for example the buffers and/or compositions used for extracting nucleic acids or other target molecules. This embodiment is feasible, if the malodour counteractant does not interfere with the intended downstream application.

Furthermore, the present invention pertains to the use of at least one malodour counteractant for preventing and/or suppressing malodour formation during the preparation and/or processing of a biological sample, wherein, preferably, said preparation and/or processing is selected from the group consisting of cell culturing, sample lysis, isolation of biomolecules, nucleic acid purification, protein denaturation and protein purification. Also provided is a method for isolating a biomolecule, preferably nucleic acids or proteins, from a biological sample, characterised in that at least one malodour counteractant is used for preventing and/or suppressing malodour formation during the preparation and/or processing of a biological sample. Details with respect to the malodour counteractant and specific embodiments of the invention are described above, it is referred to the above disclosure.

Also provided is a laboratory vessel for harbouring and/or processing a biological sample, wherein said vessel comprises at least one malodour counteractant. Details with respect to said vessel and the comprised malodour counteractant are described above in conjunction with the method and are also summarised in the claims. It is referred to the respective disclosure.

### EXAMPLES

The examples provided below exemplify some of the embodiments of this invention, but are not limited to such, which can be used as malodour counteracting agents during nucleic acid isolation from bacterial cultures, as one example for the isolation of biomolecules. Furthermore, the examples demonstrate that the choice of the right combination respectively matching of malodour counteractant and biological sample is important to achieve effective malodour suppression, while not interfering with the intended processing/preparation of the biological sample, in particular when isolating biomolecules such as nucleic acids therefrom.

### Example 1

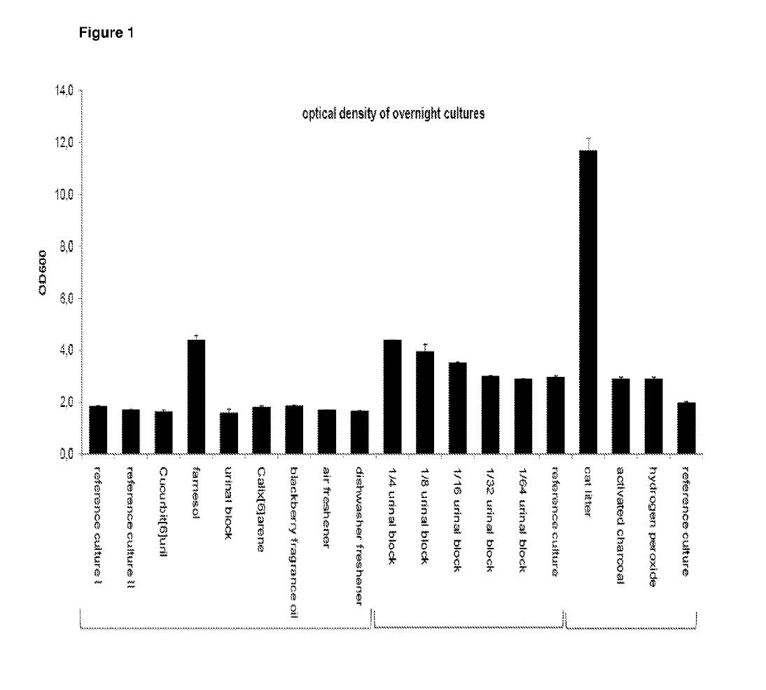

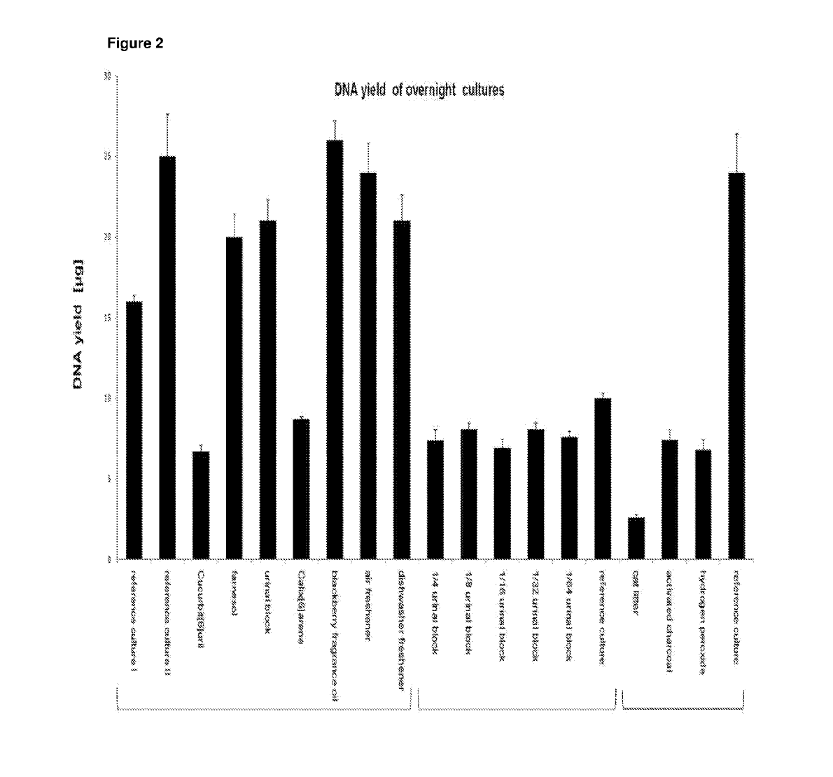

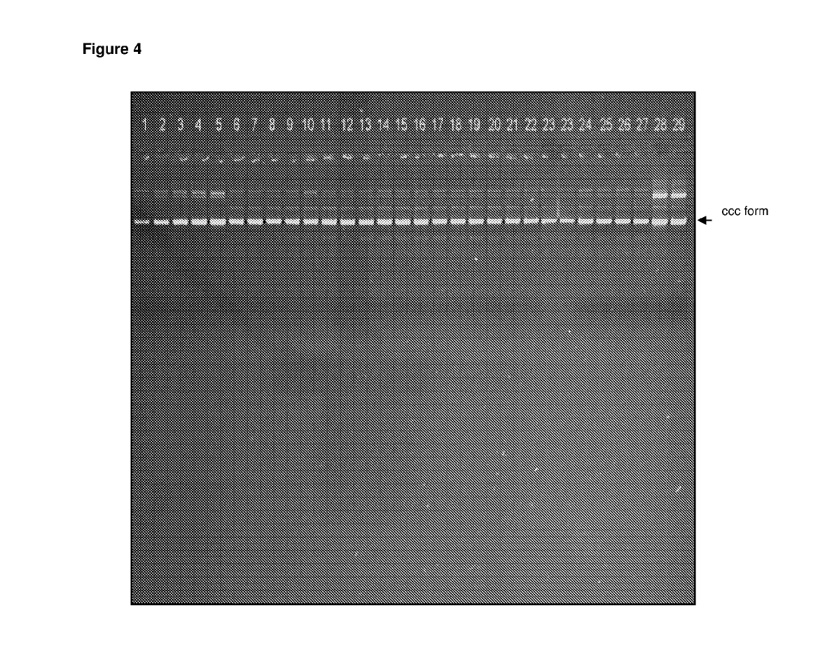

To identify and evaluate the potential of different available materials and compounds as malodour counteractants, in particular fragrances, air fresheners or hygiene articles, to reduce the malodour nuisance that arises during sample processing of E. coli cultures in laboratory scale without interfering with bacterial growth or subsequent DNA isolation and quality, the following experiments were carried out:
1. Small-scale overnight cultures of E. coli DH5α harboring a plasmid pCMVβ were grown over night in antibiotic-containing LB medium.
   500 ml, 250 ml and 200 ml LB cultures were then inoculated with 1:1000 (v/v) of the small-scale culture in regular flasks.
2. The materials and compounds to be tested were, where feasible, either soaked into an empty tea bag or placed inside an empty tea bag, which was then positioned inside the respective culture flask. The tea bag was then attached to the culture flask (directly below the opening) with adhesive tape, which was also used to seal the flask. The tea bags were not in direct contact with the culture. An overview over the materials and compounds that were used as malodour counteractants and further details of the individual test are summarized in Table 1A, which also contains a brief summary of the major findings for the respectively tested malodour counteractants. Cultures, wherein no malodour counteractant was added were used as reference (“reference culture”).
3. The cultures were then grown over night at 37° C. at 160 rpm on an orbital shaker.
4. The next day, cultures were inspected with respect to their optical density (OD₆₀₀) and malodour formation immediately after growth. Bacteria were then pelletized by centrifugation (see below), the supernatant was discarded and the scent of the bacterial pellets was examined.
5. To determine the extent to which the malodour countercatants tested interfere with bacterial growth and thus with DNA yield, nucleic acid isolation was performed. 4×1.5 ml of each culture was used for DNA preparations using a “QIAprep Spin Miniprep” kit following the instructions provided within the kit. The remaining liquid culture was pelleted in 50 ml aliquots and stored at −20° C.
6. The resulting OD₆₀₀ readings of the overnight E. coli cultures as well as the photometric quantification of the DNA preparations are given in FIG. 1 and FIG. 2.
7. The DNA quality is essential for certain downstream applications such as gene transfer (e.g. transfection) in vitro and in vivo. Therefore, the effect of the tested malodour counteractants on plasmid DNA quality was evaluated. The ccc DNA topology of the plasmid is the most efficient for gene delivery in vitro and in vivo in comparison to open-circular (oc) and linear DNA topologies. For the scope of the tests, DNA quality was assessed as the relative amount of the “ccc” (circular covalently closed) form of plasmid DNA present in each preparation visualized by gel electrophoresis, examples of which are given in FIGS. 4-7.

The details of the tested malodour counteractants and the results of example 1 are shown in Tab. 1A and FIGS. 1 to 7 and are discussed in further detail in conjunction with the table and figure legends respectively.

The findings summarized in Table 1A demonstrate that not all malodour counteractants are suitable and in particular equally suitable to inhibit malodour formations. From the tested compounds, with respect to the smell, the dishwasher fragrance, the dishwasher neutralizer the blackberry fragrance, the urinal block (in the right concentration) and the air freshener provided the best results, the dishwasher fragrance being the best. With respect to the other tested features it was found that some of the ingredients of the tested malodour counteractants that were effective in reducing the smell had a negative influence on the preparation and/or processing of the sample. E.g. the urinal block lead to foaming, influenced the pellet and also decreased the DNA yield. Thus, it is preferred that only the fragrances thereof are used and not the whole formulation which apparently also comprised foaming agents. The dishwasher fragrance did not have any negative effects on the tested properties and thus is particularly suitable for suppressing malodour formation during the preparation and/or processing of bacterial cultures such as E. coli cultures. Furthermore, Table 1A also demonstrates that it is important to use the right malodour counteractant for each sample, because not all malodour counteractants are equally effective in suppressing malodour formation and furthermore, can also interfere with the intended downstream applications.

TABLE 1A
Materials and compounds which were used for the experiment. Provided are also the major findings for each of the conditions tested.

| Malodour | | | | | Smell of | additional | |
|---|---|---|---|---|---|---|---|
| counteractant | Function | Formulation | Optical impression | Olfactory note | bacterial pellet | observation | DNA yield |
| Cucubit[6]uril | smell | powder filled in tea | as reference | as reference | as reference | | as reference |
| | neutralizer | filter | | | | | |
| | | 150 mg in 500 ml | | | | | |
| | | culture | | | | | |
| | | 830 mg in 200 ml | | | | | |
| | | culture | | | | | |
| Calix[6]arene | smell | powder filled in tea | as reference | as reference | as reference | | as reference |
| | neutralizer | filter | | | | | |
| | | 200 mg in 250 ml | | | | | |
| | | culture | | | | | |
| Farnesol | smell | 1 ml applied on tea | turbid and milky, | as reference or even | as reference or | bacteria did | as reference |
| | neutralizer | filter for 500 ml culture | brighter than | slightly worse | even slightly | not pelletize | |
| | and | | reference | | worse | completely, | |
| | fragrance | | | | | residual | |
| | | | | | | bacteria in | |
| | | | | | | supernatant; | |
| | | | | | | OD₆₀₀ | |
| | | | | | | unusually high | |
| Blackberry | Fragrance | some droplets applied | as reference | mixture of E. coli and | | | as reference |
| fragrance Oil | | on tea filter for 250 ml | | blackberry smell | | | |
| | | culture | | | | | |
| H₂O₂ | smell | 5 ml 0.3% soaked into | as reference | as reference | | | as reference |
| | neutralizer, | tea filter for 200 ml | | | | | |
| | chemical | culture | | | | | |
| | substance | | | | | | |
| Activated | smell | 2 g filled in tea filter for | as reference | as reference | | | as reference |
| carbon | neutralizer | 200 ml culture, a | | | | | |
| | | second tea filter was | | | | | |
| | | used to envelope the | | | | | |
| | | first one | | | | | |
| Cat litter | smell | 4.5 g filled in tea filter | turbid, brighter than | as reference | | Small particles | 50% of |
| | neutralizer | for 200 ml culture | reference | | | of cat litter got | reference |
| | | | | | | into culture | |
| air freshener: | Fragrance | some droplets applied | as reference | mixture of E. coli | | | as reference |
| liquid taken | | on tea filter for 250 ml | | smell and smell of air | | | |
| from | | culture | | freshener | | | |
| evaporator | | | | | | | |
| urinal block | fragrance, | ¼, ⅛, 1/16, 1/32 and | 1/32, 1/64: as | ¼ and ⅛: smell of | | ¼- 1/16: | >80% of |
| | formulation | 1/64 of the block was | reference | toilet block, no smell | | bacterial pellet | reference |
| | containing | incorporated in tea | 1/16 ¼: increasing | of E. coli. | | was difficult to | |
| | several | filter for 200 ml culture | amount of foam, | 1/16- 1/64 mixture of | | resuspend | |
| | fragrances | | brighter colour | both, increasing | | | |
| | and other | | | smell of E. coli | | | |
| | substances | | | | | | |
| | like | | | | | | |
| | detergents | | | | | | |
| dishwasher | fragrance, | complete module used | as reference | smell of dishwasher | decent smell of | | as reference |
| fragrance | formulation | for 250 ml culture | | fragrance, no smell | lemon | | |
| (“Calgonit | filled in | | | of E. coli | | | |
| finish”) | membrane | | | | | | |
| dishwasher | fragrance, | complete module used | as reference | smell of dishwasher | marginal smell | | As reference |
| malodour | formulation | for 250 ml culture | | Neutralizer, no smell | of malodour | | (94% of |
| Neutralizer by | filled in | | | of E. coli - fresh | neutralizer, | | reference) |
| Calgonit | membrane | | | smell | rather neutral | | |
| air freshener | smell | applied into the air at | for a very short time | as reference | | | |
| (room spray) | neutralizer | time of transfer of | reduction of E. coli | | | | |
| | and | E. coli culture into | smell, but smell still | | | | |
| | fragrance | centrifuge tubes | persists. After a | | | | |
| | | | brief period of time | | | | |
| | | | smell as reference | | | | |
| | | | again | | | | |

### Example 2

A second set of substances according to Table 1B was assessed for the ability to act as malodour counteractants. In example 2, the compounds were not used during the growth of the respective cultures, but were directly added to the resuspension buffer of the kit used for the plasmid DNA preparation (QIAprep Spin Miniprep). Thus, the malodour counteractants were in direct contact with the sample.

First, the influence of the fragrances listed in Table 1B on plasmid DNA yield was assessed. For each DNA preparation, 5 ml of overnight bacterial culture were used with the bacteria harboring the pCMVp plasmid. For the DNA purification a Qiagen “QIAprep Spin Mini” kit was used along with the buffers provided within the kit. The following amounts of substances were added to 250 μl of resuspension buffer P1: 30 μl air freshener, 0.0671 g coumarin dissolved in 1 ml of P1 of which 250 μl were then used, 30 μl citronellol, 30 μl linalool, 30 μl benzyl salicylate, a mixture of 0.0623 g coumarin and 30 μl each of cironellol, linalool, benzyl salicylate in 1 ml of P1 (from here on referred to as “mix”) of which 250 μl were then used. As reference, preparations without the addition of a fragrance were used.

Example 2 showed that all malodour counteractants tested were able to suppress the malodour which developed during resuspension in buffer P1. In combination with the biomass pellet and after the addition of P2, all samples maintained the smell of the fragrance that was added to P1. The samples with coumarin, the tested mixture, citronellol and linalool in P1 showed after the addition of P2 lighter blue coloring (blue color was due to the addition of LysisBlue) than the reference and the samples comprising air freshener and benzyl salicylate in P1. However, upon adding buffer N3 (which comprises chaotropic salts), some compounds failed to serve as malodour counteracting agent. After addition of N3, only the samples comprising the mixture, citronellol and linalool kept the pleasant smell. With all other samples, the N3 odor dominated. In addition, the compounds differentially affected the precipitation of genomic DNA and cellular debris through the addition of buffer N3. This is illustrated in subsequent Table 1B. Other factors that made certain compounds more useful in their function as a malodour counteracting agent was their ability to mix with the resuspension buffer P1, as shown in Table 1B.

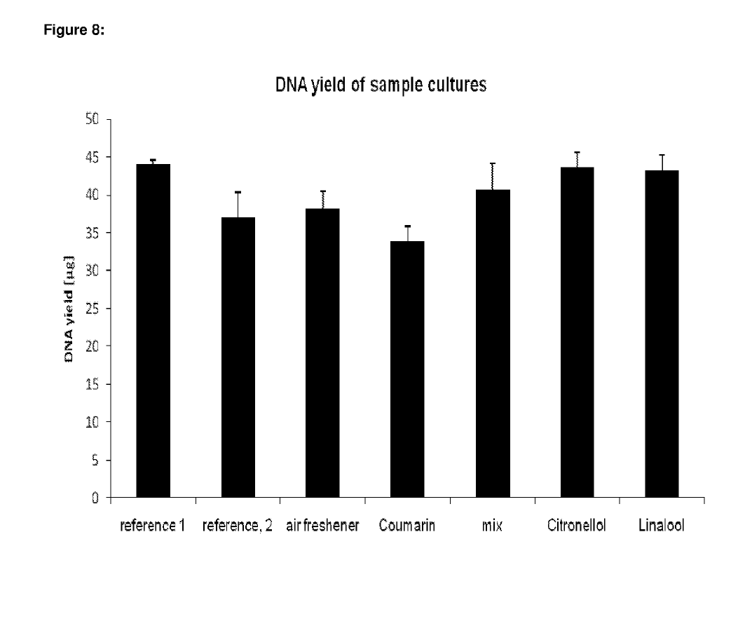

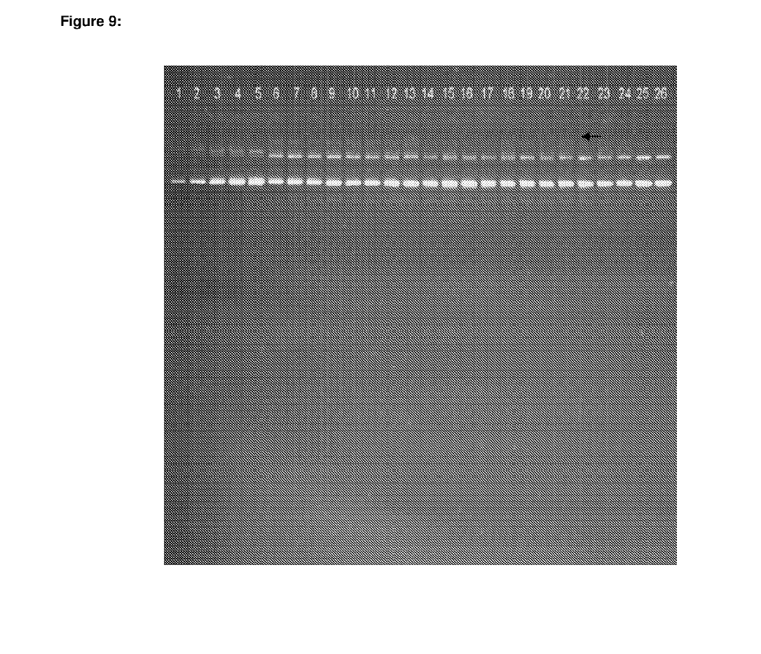

Next, following the assessment of the malodour counteracting potential of the substances, their influence on the resulting DNA yield and quality was assayed by photometric analysis and gel electrophoresis as done before (see FIGS. 8, 9). The samples comprising air freshener, coumarin and the mixture of coumarin, citronellol, linalool and benzyl salicylate in P1 rendered reduced DNA yields compared to the reference. The samples comprising citronellol, linalool and benzyl salicylate in P1 did not show any significant differences with respect to DNA yield compared to the reference. Furthermore, also with respect to quality, no difference was seen. All samples showed a slight smear above the oc band and a further additional faint band between ccc and oc. Furthermore, all samples showed in addition a band which migrated just below the ccc form.

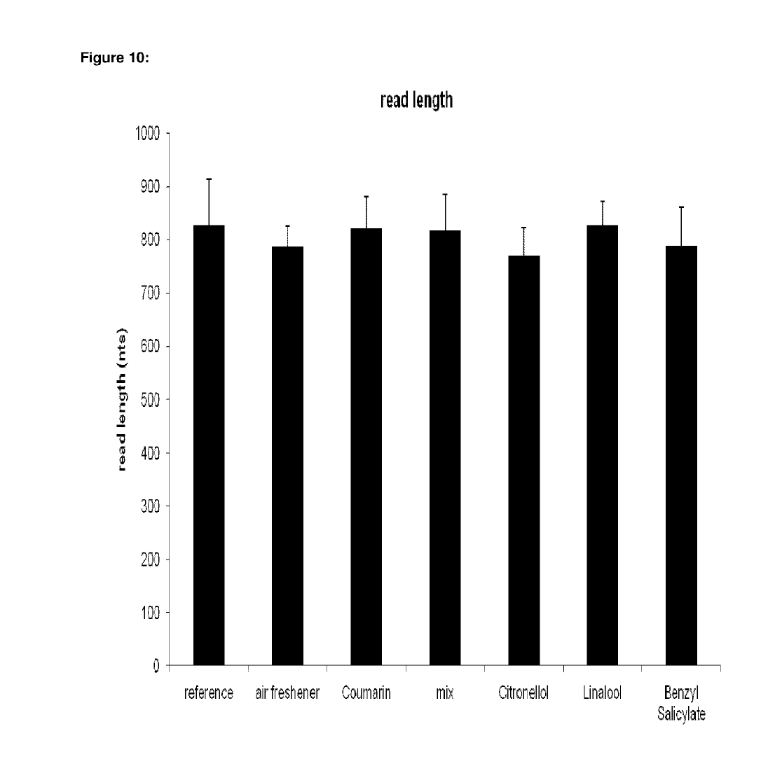

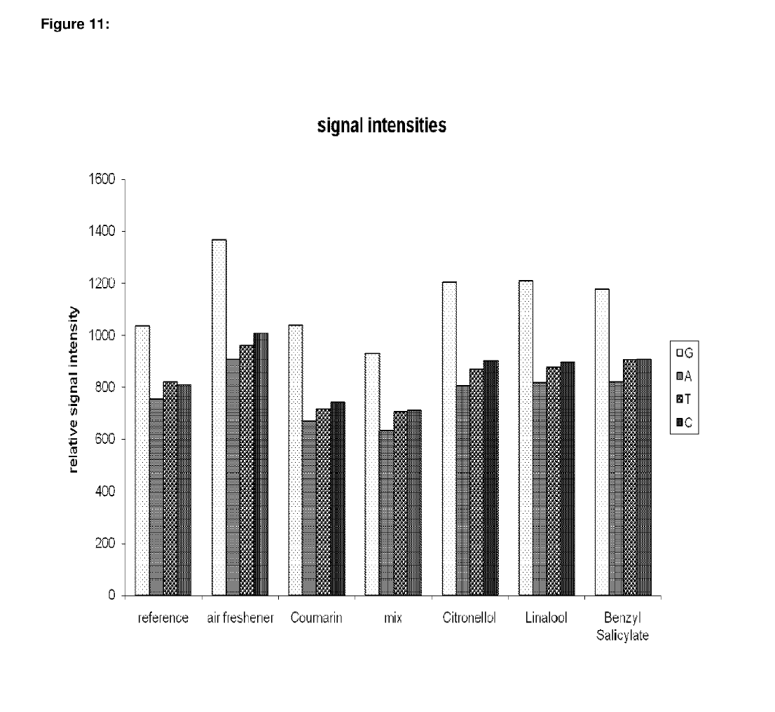

Moreover, DNA quality was assayed in DNA sequencing reactions, which are a common subsequent downstream application in molecular biology. Here, the resulting length of the sequencing run as well as the mean signal intensity of each of the four nucleobases was assessed for each sample (see FIGS. 10, 11). Table 2 lists the raw data of the sequencing reactions along with observations concerning the influence of the compounds on the sequencing reaction and sequencing gel run. While all substances and mixtures thereof as listed in Table 1B resulted in approximately equal sequencing run lengths, some of the compounds appear to dampen the signal intensities of individual sequencing reactions (see FIG. 11). Furthermore, the malodour counteractants added to P1 had an influence on the sequence in that the beginning was delayed.

Thus, the malodour counteractant must be carefully chosen in order to avoid an interference with downstream applications which may comprise enzymatic reactions such as sequencing. Other examples for downstream applications may include, but are not limited to, polymerase chain reaction, in vitro translation, restriction digests or pronuclear injection for the generation of transgenic animals.

TABLE 1B
Materials and compounds, which were assessed for their potential to act as malodour counteractants
when directly added to the resuspension buffer P1 during DNA preparation from small scale cultures.

| | P1 with LyseBlue + | resus- | Smell following | Smell following | |
|---|---|---|---|---|---|
| Substance | biomass | pension | addition of buffer P2 | addition of buffer N3 | oberservations/comments |
| Reference | Slightly acidic | OK | Slightly acidic scent | Smell of N3 | |
| | scent | | | | |
| Air freshener | Smell o fair | OK | Smell of air freshener | Smell of N3 | Air freshener mixed well |
| | freshener | | | | with buffer P1. |
| Coumarin | Smell of | OK | Smell of coumarin, Light | Smell of N3 | Coumarin did not dissolve in P1. |
| | coumarin | | blue color following | | |
| | | | the addition P2 | | |
| Mixture of coumarin, | scent of | OK | Smell of mixture; Light | Smell of mixture, | Coumarin did not dissolve in P1, |
| citronellol, | mixture | | blue color following the | barely noticeable | citronellol, linalool und benzyl |
| linalool, benzyl | | | addition P2 | smell of N3 | salicylate were only partially |
| salicylate | | | | | miscible with buffer P1. |
| Citronellol | Smell of | OK | Smell of citronellol. Light | Smell of citronellol, | Citronellol was only partially |
| | citronellol | | blue color following the | barely noticable | miscible with buffer P1, |
| | | | addition of P2, | smell of N3 | sample contained precipitated |
| | | | | | genomic DNA. Genomic DNA, cellular |
| | | | | | debris and SDS did not pelletize |
| | | | | | well and portions thereof were |
| | | | | | swimming in the lysate. |
| Linalool | Smell of | OK | Smell of linalool, Light | Smell of linalool, | Linalool was not completely miscible |
| | linalool | | blue color following the | smell of N3 barely | with P1. |
| | | | addition of P2 | noticeable | All samples contained precipitated |
| | | | | | genomic DNA. |
| | | | | | Genomic DNA, cellular debris and SDS |
| | | | | | did not pelletize well and portions |
| | | | | | thereof were swimming in the lysate. |
| Benzyl salicylate | Smell of benzyl | OK | Smell of benzyl salicylate | Smell of N3 | Benzyl salicylate was only partially |
| | salicylate | | | | miscible with P1. |

TABLE 2
Sequencing results of DNA samples that were prepared in the presence of the substances listed in Table 1B. Listed are read length,
signal intensities for the corresponding sample, average signal intensity for the bases within each sample as well as remarks about
the sequencing run itself.

| | | | | | | | | | | Signal | Signal | Signal | Signal |
|---|---|---|---|---|---|---|---|---|---|---|---|---|---|
| | | | | | | | | | | intensity | intensity | intensity | intensity |
| Sample | Name | G | A | T | C | Start | Stop | Readlength | Mean | [G] | [A] | [T] | [C] |
| Reference, 1 | C035 1a UP.at | 1219 | 847 | 915 | 918 | 21 | 904 | 883 | 828 | 1038 | 756 | 822 | 809 |
| Reference, 2 | C035 1b UP.at | 864 | 694 | 751 | 715 | 51 | 780 | 729 | | | | | |
| Reference, 3 | C035 1c UP.at | 1031 | 728 | 799 | 795 | 33 | 906 | 873 | | | | | |
| Liquid air | C035 2a UP.at | 1579 | 1094 | 1146 | 1197 | 53 | 866 | 813 | 787 | 1368 | 909 | 962 | 1006 |
| freshner, 1 | | | | | | | | | | | | | |
| Liquid air | C035 2b UP.at | 1410 | 907 | 942 | 1000 | 82 | 825 | 743 | | | | | |
| freshner, 2 | | | | | | | | | | | | | |
| Liquid air | C035 2c UP.at | 1114 | 726 | 798 | 820 | 22 | 828 | 806 | | | | | |
| freshner, 3 | | | | | | | | | | | | | |
| Coumarin, 1 | C035 3a UP.at | 1157 | 777 | 829 | 863 | 36 | 926 | 890 | 821 | 1039 | 669 | 715 | 743 |
| Coumarin, 2 | C035 3b UP.at | 967 | 618 | 658 | 692 | 51 | 838 | 787 | | | | | |
| Coumarin, 3 | C035 3c UP.at | 994 | 611 | 657 | 673 | 34 | 820 | 786 | | | | | |
| Mix (see table | C035 4a UP.at | 754 | 481 | 546 | 577 | 23 | 916 | 893 | 817 | 930 | 634 | 706 | 710 |
| 1B), 1 | | | | | | | | | | | | | |
| Mix (see table | C035 4b UP.at | 1124 | 761 | 836 | 846 | 40 | 837 | 797 | | | | | |
| 1B), 2 | | | | | | | | | | | | | |
| Mix(see table 1B), 3 | C035 4c UP.at | 912 | 661 | 736 | 707 | 99 | 860 | 761 | | | | | |
| Citronellol, 1 | C035 5a UP.at | 1288 | 865 | 887 | 967 | 97 | 929 | 832 | 770 | 1203 | 806 | 868 | 901 |
| Citronellol, 2 | C035 5b UP.at | 1203 | 780 | 867 | 868 | 98 | 839 | 741 | | | | | |
| Citronellol, 3 | C035 5c UP.at | 1119 | 772 | 851 | 868 | 99 | 836 | 737 | | | | | |
| Linalool, 1 | C035 6a UP.at | 1205 | 840 | 882 | 912 | 25 | 841 | 816 | 828 | 1209 | 819 | 874 | 897 |
| Linalool, 2 | C035 6b UP.at | 1125 | 754 | 814 | 813 | 47 | 924 | 877 | | | | | |
| Linalool, 3 | C035 6c UP.at | 1297 | 863 | 926 | 965 | 51 | 842 | 791 | | | | | |
| Benzyl Salicylate, 1 | C035 7a UP.at | 1155 | 798 | 871 | 872 | 55 | 927 | 872 | 788 | 1177 | 820 | 905 | 908 |
| Benzyl Salicylate, 2 | C035 7b UP.at | 1063 | 751 | 843 | 838 | 46 | 798 | 752 | | | | | |
| Benzyl Salicylate, 3 | C035 7c UP.at | 1314 | 911 | 1002 | 1013 | 102 | 843 | 741 | | | | | |

Table 2 provides information with respect to the sequencing run and the effect of the malodour counteracting fragrances on the sequencing reaction. It should be noted that some compounds did interfere with the beginning of readable sequencing information. Especially when using citronellol, the starting point of the sequencing reaction was delayed. However, the overall quality of the sequencing run was comparable to that of the reference plasmid DNA.

### Example 3

In a third set of experiments malodour counteractants (see Table 3) were applied to a filter and comprised in the biomass pellet during workup of the samples such that the malodour counteractant was in direct contact with the bacterial pellet.

Example 3 showed that all tested malodour counteractants were able to suppress the malodour which emanates from the pellet, however to a different extent. While the mixture of coumarin, citronellol, linalool, benzyl salicylate was most effective in suppressing the malodour, coumarin and the liquid air freshener were less effective.

The use of the malodour counteractant mixture was able to suppress the malodour all the way through the workup process, with only a faint smell of buffer N3 (QIAGEN) in the end, while the scent of the mixture could still be perceived. The use of liquid air freshener was almost as effective as malodour counteractant, however, following the addition of N3 the scent of the air freshener could no longer be perceived, instead a faint smell of buffer N3 emanated from the sample. The use of coumarin alone was less effective in suppressing the malodour. Even though providing an improvement, the bacterial smell was faintly perceived following the addition of the filter paper to the bacterial pellet as well as during resuspension and the subsequent addition of buffers P2 (QIAGEN) and N3 (QIAGEN).

Furthermore, the influence of the malodour counteractants on the resulting pellet after centrifugation of the lysate was tested. All samples show a compact pellet following centrifugation of the lysate with some smear. Furthermore, their influence on the resulting DNA yield and quality was tested. The sample with the liquid air freshener did not show any difference with respect to the DNA yield compared to the reference. The samples with coumarin and the mixture showed only a slightly reduced yield compared to the reference which was, however, still acceptable.

TABLE 3
Materials and compounds, which were assessed for their ability to act as malodour counteractants
when applied to a filter paper and included into the biomass pellet.

| | | P1 (QIAGEN) with | | | | |
|---|---|---|---|---|---|---|
| Substance | Pellet with filter | LyseBlue + Biomass | Resuspension | + P2 (QIAGEN) | +N3 (QIAGEN) | Comments |
| Reference | | Slightly acidic scent | Pellet was | Slightly acidic scent | Smell of N3 | Compact pellet after |
| | | | difficult to | | | centrifugation of the lysate |
| | | | dissolve from | | | with some smear |
| | | | the bottom, | | | |
| | | | otherwise O.K. | | | |
| Liquid air | Smell of air freshener | Smell of air freshener | as reference | Smell of air freshener | Faint smell of N3 | Compact pellet after |
| freshener | | | | | | centrifugation of the lysate |
| | | | | | | with some smear, DNA yield |
| | | | | | | as reference |
| Coumarin | Smell of coumarin, | Smell of coumarin, | as reference | Smell of coumarin, | Smell of | Compact pellet after |
| | partially faint smell of | partially faint smell of | | partially faint smell of | coumarin and N3 | centrifugation of the lysate |
| | bacterial culture | bacterial culture | | bacterial culture | | with some smear, 85% DNA |
| | | | | | | yield of reference |
| Mixture of | Scent of mixture, with | Scent of mixture, | as reference | Scent of mixture | Scent of mixture | Compact pellet after |
| coumarin, | an underlying faint | coumarin predominant | | | faint smell of N3 | centrifugation of the lysate |
| citronellol, | smell of the bacterial | | | | | with some smear, only in |
| linalool, | culture | | | | | sample 3 some of the |
| benzyl | | | | | | precipitate was pipetted onto |
| salicylate | | | | | | the column, 85% DNA |
| | | | | | | yield of reference |

### FIG. 1:

Comparison of bacterial growth in overnight cultures in the presence of the substances listed in Table 1A. The OD₆₀₀ values represent mean values of 2 independent measurements.

In FIG. 1, cultures that were grown and characterized within one experiment are encompassed by brackets. Where necessary, overnight cultures were diluted 1:10 for measurements and OD₆₀₀ values were extrapolated. The results indicated that certain materials and compounds do affect the optical density of the bacterial culture compared to the reference culture, namely farnesol, urinal block, hydrogen peroxide, activated charcoal and especially cat litter (small particles got into culture) did affect the optical density of the overnight cultures.

### FIG. 2:

Resulting DNA yield of pooled 4×1.5 ml overnight cultures prepared using a “Qiaprep Spin Mini” kit. The nucleic acid concentration of the samples was determined photometrically. Comparison of optical densities of individual cultures (FIG. 1) with the corresponding DNA yield of the cultures (FIG. 2) revealed that the materials and compounds tested differentially affected OD₆₀₀ and DNA yield. For example, the culture grown in the presence of cat litter showed the highest optical density at λ=600 nm, most likely due to disintegration of the cat litter in the bacterial culture, while its DNA yield was the lowest of the conditions tested. Other substances tested, such as farnesol appeared to have a moderate effect on bacterial growth, while not affecting DNA yield of the respective cultures.

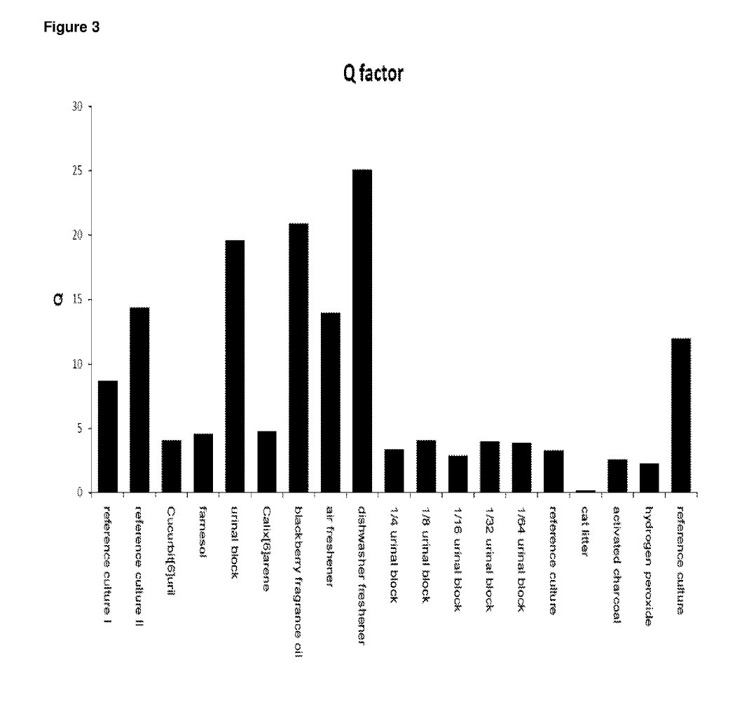

### FIG. 3:

For better visualization and integration of the effect of a given substance or compound on DNA yield, optical density and olfaction, a dimensionless factor was introduced, which is calculated by

Q=[DNA yield]/OD₆₀₀*f,

whereby
f=1 for samples that smell like reference culture,
f=1.5 for samples that have a slightly improved smell, or
f=2 for samples that do have no E. coli smell.

The “Q factor” allows to better compare the substances tested and reveals that the use of dishwasher freshener does achieve the most satisfactory results with respect to DNA yield, bacterial growth and elimination of malodour nuisance. Other substances, such as for example urine block and fractions thereof, did suppress E. coli smell, however the DNA yield of the cultures was lower and thus the Q factor is about the same value as the one for the respective reference culture. The Q factor also revealed the poor overall performance of cat litter as a malodour counteracting agent.

As the Q factor also reflects DNA yield of a given culture it was to be expected that the Q factor for “reference culture I”, which was used as a “starter culture”, would be smaller than that of the other reference cultures used in the experiment. It should be noted that the Q factor is only valid for bacterial cultures that were grown under comparable conditions, most importantly, culture volume, temperature and culturing time. Thus, “reference culture II” and “reference culture” are of particular interest for comparing the effect of the materials and compounds tested. As before, comparable growth conditions are indicated by brackets.

### FIG. 4:

DNA quality is important for applications such as in vivo or in vitro gene delivery. It was therefore important to assess the quality of the DNA resulting from the individual preparations. For quality assessment of plasmid DNA prepared from cultures that were grown in the presence of the substances listed in Table 1A approximately 100 ng of uncut plasmid DNA were resolved on a 1% agarose gel, to estimate the relative amount of ccc plasmid DNA in relation to oc or linear plasmid DNA. The gel was run in 1×TAE buffer at 100V for 75 minutes and ethidium bromide stained during the gel run.

The arrow indicates the ccc DNA topology isoform, which migrates faster in the applied electrical field than oc or linear plasmid DNA topologies. Compared to pCMVβ standard (lanes 1-5) and reference culture II (lanes 28, 29) the relative amount of ccc plasmid DNA in samples 6-27 is comparable to that of the controls, indicative of similar DNA quality.

The gel was loaded according to the following order:

| Lane | Sample |
|---|---|
| 1 | pCMVβ standard, 60 ng |
| 2 | pCMVβ standard, 90 ng |
| 3 | pCMVβ standard, 120 ng |
| 4 | pCMVβ standard, 150 ng |
| 5 | pCMVβ standard, 180 ng |
| 6 | Starter culture |
| 7 | Starter culture |
| 8 | Culture with cat litter |
| 9 | Culture with cat litter |
| 10 | Culture with cat litter |
| 11 | Culture with cat litter |
| 12 | Culture with activated charcoal |
| 13 | Culture with activated charcoal |
| 14 | Culture with activated charcoal |
| 15 | Culture with activated charcoal |
| 16 | Culture with hydrogen peroxide |
| 17 | Culture with hydrogen peroxide |
| 18 | Culture with hydrogen peroxide |
| 19 | Culture with hydrogen peroxide |
| 20 | Culture with curcubit[6]ane |
| 21 | Culture with curcubit[6]ane |
| 22 | Culture with curcubit[6]ane |
| 23 | Culture with curcubit[6]ane |
| 24 | Culture with calix[6]arene |
| 25 | Culture with calix[6]arene |
| 26 | Culture with calix[6]arene |
| 27 | Culture with calix[6]arene |
| 28 | Reference culture II (FIG. 3) |
| 29 | Reference culture II (FIG. 3) |

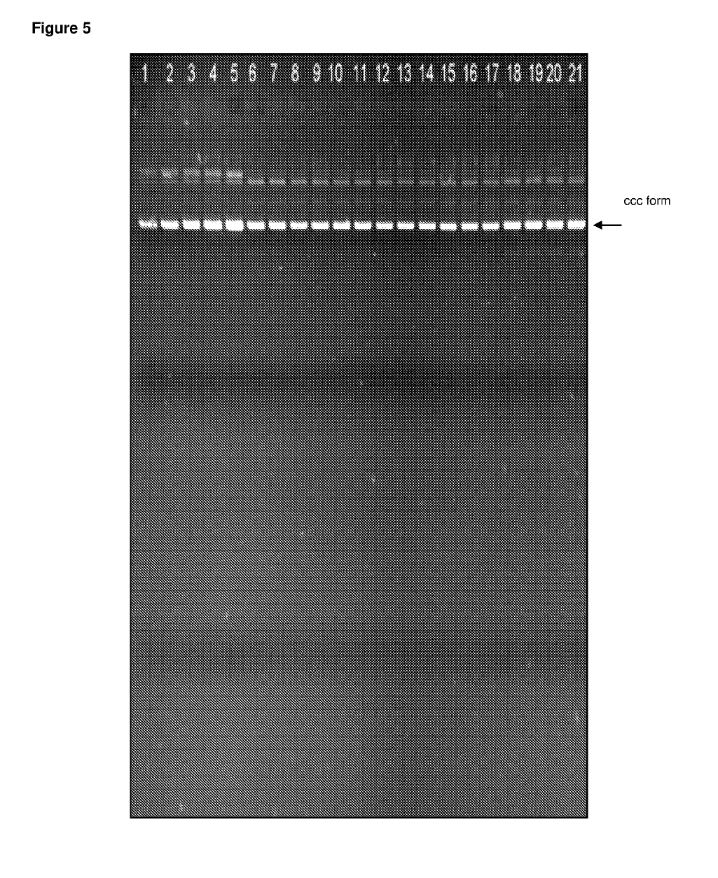

### FIG. 5:

Quality assessment of plasmid DNA prepared from “reference culture I” and cultures that were grown in the presence of curcubit[6]ane, farnesol or urine block. A 1% agarose gel was run in 1×TAE buffer at 100V for 75 minutes, ethidium bromide stained during the gel run and approximately 100 ng of uncut plasmid DNA were loaded as indicated (see gel loading order). The relative abundance of ccc plasmid DNA within samples 6-21 indicates comparable DNA quality.

The loading order of the gel was as listed below:

| Lane | Sample |
|---|---|
| 1 | pCMVβ standard, 60 ng |
| 2 | pCMVβ standard, 90 ng |
| 3 | pCMVβ standard, 120 ng |
| 4 | pCMVβ standard, 150 ng |
| 5 | pCMVβ standard, 180 ng |
| 6 | Reference culture I (FIG. 2) |
| 7 | Reference culture I (FIG. 2) |
| 8 | Reference culture I (FIG. 2) |
| 9 | Reference culture I (FIG. 2) |
| 10 | Culture with curcubit[6]ane |
| 11 | Culture with curcubit[6]ane |
| 12 | Culture with curcubit[6]ane |
| 13 | Culture with curcubit[6]ane |
| 14 | Culture with farnesol |
| 15 | Culture with farnesol |
| 16 | Culture with farnesol |
| 17 | Culture with farnesol |
| 18 | Culture with urine block |
| 19 | Culture with urine block |
| 20 | Culture with urine block |
| 21 | Culture with urine block |

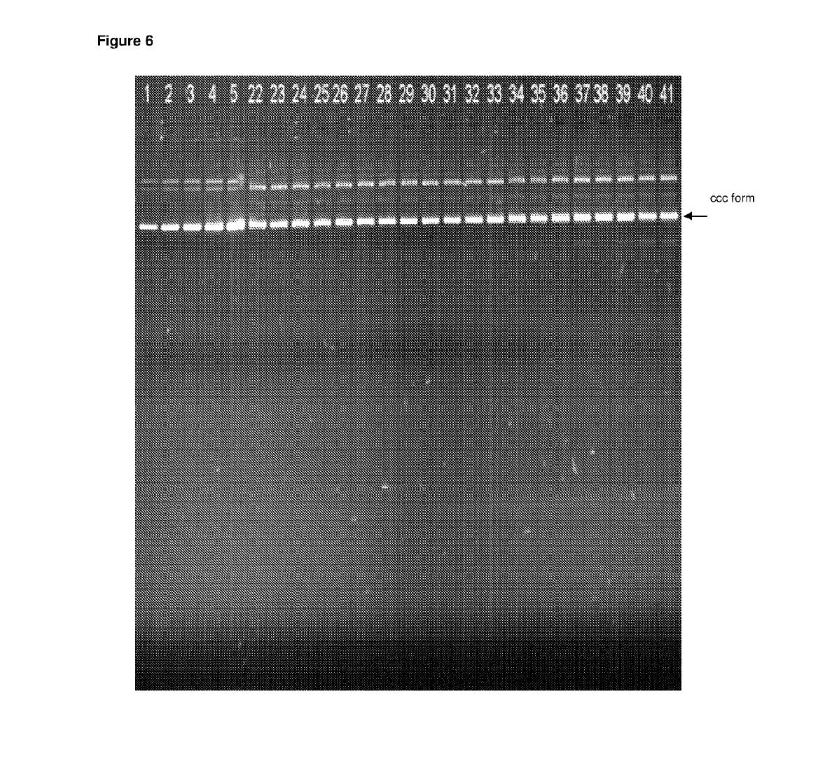

### FIG. 6:

Quality assessment of plasmid DNA prepared from cultures that were grown in the presence of calix[6]arene, blackberry fragrance, air freshener or dishwasher freshener in comparison to “reference culture II” and pCMV5 standard. The 1% agarose gel was run in 1×TAE buffer at 100V for 75 minutes and ethidium bromide stained during the gel run.

The gel was loaded according to the following order according to the numbers above each lane:

| Lane | Sample |
|---|---|
| 1 | pCMVβ standard, 60 ng |
| 2 | pCMVβ standard, 90 ng |
| 3 | pCMVβ standard, 120 ng |
| 4 | pCMVβ standard, 150 ng |
| 5 | pCMVβ standard, 180 ng |
| 22 | Reference culture II (FIG. 2) |
| 23 | Reference culture II (FIG. 2) |
| 24 | Reference culture II (FIG. 2) |
| 25 | Reference culture II (FIG. 2) |
| 26 | Culture with Calix[6]arene |
| 27 | Culture with Calix[6]arene |
| 28 | Culture with Calix[6]arene |
| 29 | Culture with Calix[6]arene |
| 30 | Culture with blackberry fragrance oil |
| 31 | Culture with blackberry fragrance oil |
| 32 | Culture with blackberry fragrance oil |
| 33 | Culture with blackberry fragrance oil |
| 34 | Culture with air freshener |
| 35 | Culture with air freshener |
| 36 | Culture with air freshener |
| 37 | Culture with air freshener |
| 38 | Culture with dishwasher freshener |
| 39 | Culture with dishwasher freshener |
| 40 | Culture with dishwasher freshener |
| 41 | Culture with dishwasher freshener |

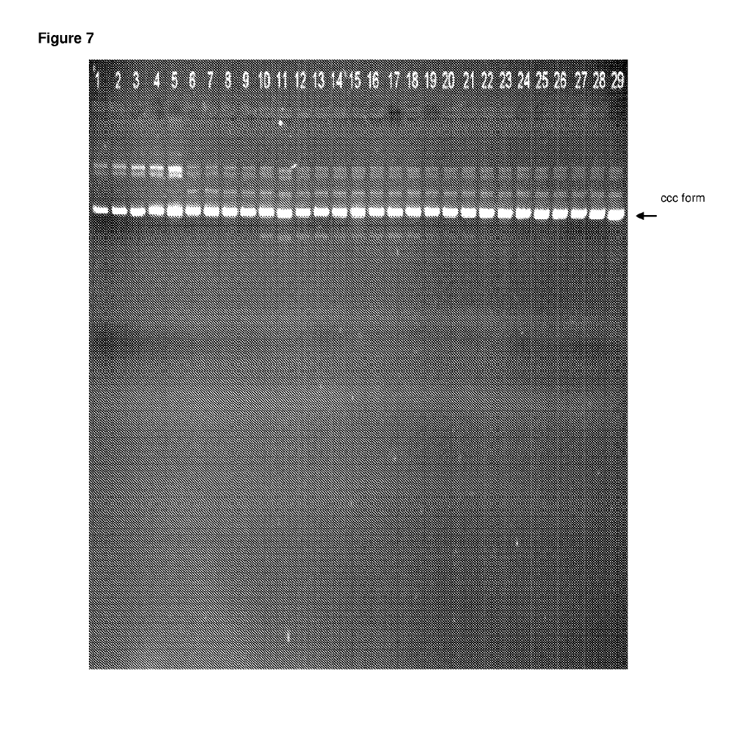

### FIG. 7:

Influence of varying amounts of urine block on bacterial growth and plasmid DNA quality was tested. The overnight cultures were grown in the presence of varying amounts of urine block (see table provided below) and DNA was isolated and quantified. The gel was loaded according to the table provided below, with ˜100 ng of plasmid DNA per lane, unless indicated otherwise. Quality assessment of plasmid DNA prepared from cultures that were grown in the presence of varying amounts of urine block. The 1% agarose gel was run in 1×TAE buffer at 100V for 75 minutes and stained with ethidium bromide during the gel run. Approximately 100 ng of plasmid DNA were loaded for lanes 6-29. The presence of comparable amounts of ccc plasmid DNA in the samples indicates similar DNA quality.

The gel was loaded according to the following order according to the numbers above each lane:

| Lane | Sample |
|---|---|
| 1 | pCMVβ standard, 60 ng |
| 2 | pCMVβ standard, 90 ng |
| 3 | pCMVβ standard, 120 ng |
| 4 | pCMVβ standard, 150 ng |
| 5 | pCMVβ standard, 180 ng |
| 6 | Reference culture I |
| 7 | Reference culture I |
| 8 | Reference culture I |
| 9 | Reference culture I |
| 10 | Culture with ¼ urine block |
| 11 | Culture with ¼ urine block |
| 12 | Culture with ¼ urine block |
| 13 | Culture with ¼ urine block |
| 14 | Culture with ⅛ urine block |
| 15 | Culture with ⅛ urine block |
| 16 | Culture with ⅛ urine block |
| 17 | Culture with ⅛ urine block |
| 18 | Culture with 1/16 urine block |
| 19 | Culture with 1/16 urine block |
| 20 | Culture with 1/16 urine block |
| 21 | Culture with 1/16 urine block |
| 22 | Culture with 1/32 urine block |
| 23 | Culture with 1/32 urine block |
| 24 | Culture with 1/32 urine block |
| 25 | Culture with 1/32 urine block |
| 26 | Culture with 1/64 urine block |
| 27 | Culture with 1/64 urine block |
| 28 | Culture with 1/64 urine block |
| 29 | Culture with 1/64 urine block |

### FIG. 8:

FIG. 8 shows the results of example 2 with respect to DNA yield. DNA yields were quantified photometrically, with mean values representing 2 independent measurements for the reference culture and 3 independent measurements for each of the tested substances. Error bars indicate standard deviation. Differing from the previous examples the malodour counteracting substances were directly added to the resuspension buffer P1.

### FIG. 9:

As in the previous examples DNA quality was assessed by gel electrophoresis to quantify the amount of supercoiled ccc plasmid DNA. Approximately 100 ng of DNA were loaded per lane, except for lane 8. As indicated, increasing amounts of pCMVβ were loaded as a standard.

The 1% agarose gel was run in 1×TAE buffer at 100V for 75 minutes and was ethidium bromide stained during the gel run prior to imaging.

The gel was loaded according to the following order according to the numbers above each lane:

| Lane | Sample |
|---|---|
| 1 | pCMVβ standard, 60 ng |
| 2 | pCMVβ standard, 90 ng |
| 3 | pCMVβ standard, 120 ng |
| 4 | pCMVβ standard, 150 ng |
| 5 | pCMVβ standard, 180 ng |
| 6 | Reference culture, 1 |
| 7 | Reference culture, 2 |
| 8 | Reference culture, 3 (*) |
| 9 | Culture with air freshener, 1 |
| 10 | Culture with air freshener, 2 |
| 11 | Culture with air freshener, 3 |
| 12 | Culture with coumarin, 1 |
| 13 | Culture with coumarin, 2 |
| 14 | Culture with coumarin, 3 |
| 15 | Culture with Mix, 1 |
| 16 | Culture with Mix, 2 |
| 17 | Culture with Mix, 3 |
| 18 | Culture with Citronellol, 1 |
| 19 | Culture with Citronellol, 2 |
| 20 | Culture with Citronellol, 3 |
| 21 | Culture with Linalool, 1 |
| 22 | Culture with Linalool, 2 |
| 23 | Culture with Linalool, 3 |
| 24 | Culture with Benzyl salicylate, 1 |
| 25 | Culture with Benzyl salicylate, 2 |
| 26 | Culture with Benzyl salicylate, 3 |

(*) Reference culture 3 was prepared from less than 5 ml of bacterial culture and is thus just used for the purpose of quality assessment of the plasmid DNA.

### FIG. 10:

As an additional criterion for assessing the quality of the DNA which was prepared in the presence of the substances listed in table 1B, the resulting DNA was sequenced. The graphs shown represent the mean of the sequencing run lengths obtained. Error bars indicate the standard deviation.

All sequencing reactions resulted in runs of approximately equal lengths indicating that the malodour counteracting scents, which were included in the buffer P1 did not interfere with DNA quality.

### FIG. 11:

The signal intensities of the individual samples at G-A-T-C resolution were compared by plotting the average signal intensity for each nucleobase for each sample to assess whether the compounds used also did not interfere with overall signal intensity, despite comparable sequencing run lengths. The graphs reveal that the overall signal intensity distribution is similar in all samples examined, however coumarin and the “mix” consisting of 0.0671 g coumarin and 30 μl each of cironellol, linalool and benzyl salicylate dissolved in 1 ml of P1 resulted in overall reduced signal intensities.

1.-18. (canceled)

19. A method for preparing or processing a biological sample, comprising:
(A) preparing or processing a biological sample, wherein at least one malodour counteractant is used for preventing, reducing, masking, or suppressing (i) malodour, (ii) malodour formation during the preparation or processing of said biological sample, or (iii) both (i) and (ii).

20. The method of claim 19, wherein step (A) comprises isolating at least one target biomolecule from said biological sample.

21. The method of claim 19, wherein the sample is selected from the group consisting of eukaryotic cells, prokaryotic cells, fungi, cell cultures, stool, feces, blood, plasma, serum, body fluids, body excretions, saliva, urine, swabs, tissue, clinical samples, and samples derived therefrom.

22. The method of claim 19, wherein step (A) is selected from the group consisting of cell culturing, sample lysis, isolation of biomolecules, nucleic acid purification, protein denaturation, protein purification, isolation of metabolites, and isolation of components other than metabolites that are contained in the sample.

23. The method of claim 19, wherein the sample is selected from the group consisting of eukaryotic cells, prokaryotic cells, fungi, cell cultures, stool, feces, blood, plasma, serum, body fluids, body excretions, saliva, urine, swabs, tissue, clinical samples, and samples derived therefrom, and wherein step (A) is selected from the group consisting of cell culturing, sample lysis, isolation of biomolecules, nucleic acid purification, protein denaturation, protein purification, isolation of metabolites, and isolation of components other than metabolites that are contained in the sample.

24. The method of claim 19, wherein during step (A), at least one malodorous compound is present.

25. The method of claim 24, wherein the malodorous compound is selected from the group consisting of mercaptanes, malodorous heterocyclic aromatic amines, malodorous heterocyclic amines, malodorous heterocyclic aliphatic amines, malodorous primary aliphatic diamines, malodorous carboxylic acids and salts and esters thereof, malodorous fatty acids, malodorous alcohols, ethanol, phenol, dithiotreitole (DTT), isopropanol, and other alcohols.

26. The method of claim 19, wherein a composition that comprises or consists of a malodour counteractant is used in step (a).

27. The method of claim 26, wherein the composition consists of or comprises (i) a fragrance, (ii) a chemical substance or material that interacts with the malodour-causing substance or mixtures thereof, or (iii) both (i) and (ii), thereby reducing the malodour, the malodour formation, or both the malodour and the malodour formation.

28. The method of claim 19, wherein the malodour counteractant is capable of (i) evaporation, (ii) being dispersed into the environmental air, or (iii) both (i) and (ii).

29. The method of claim 26, wherein the composition is not in physical contact with the sample.

30. The method of claim 26, wherein the composition is in physical contact with the sample.

31. The method of claim 19, wherein the malodour counteractant is contained within a container.

32. The method of claim 31, wherein the malodour counteractant is contained within a container that is positioned inside a vessel harbouring the sample.

33. The method of claim 19, wherein the malodour counteractant is contained within a device.

34. The method of claim 33, wherein the device is a membrane that is at least permeable for the malodour counteractant.

35. The method of claim 19, wherein at least one fragrance selected from the group consisting of linalool, limonene, citral and citronellol or a mixture comprising two or more of these fragrances is used as the malodour counteractant.

36. The method of claim 19, wherein the malodour counteractant is contain in a laboratory vessel.

37. A laboratory vessel for harbouring or processing a biological sample, wherein said vessel comprises at least one malodour counteractant.

38. The laboratory vessel of claim 37, wherein the malodour counteractant has one or more of the following characteristics:
(a) it is a composition that comprises or consists of (i) a fragrance, (ii) a chemical substance or material that interacts with a malodour-causing substance or a mixture of malodour-causing substances, or (iii) both (i) and (ii), thereby reducing the malodour, the malodour formation or both the malodour and the malodour formation;
b. it is capable of (i) evaporation, (ii) being dispersed into the environmental air, or (iii) both (i) and (ii);
c. the malodour counteractant or the composition consisting of or comprising the malodour counteractant is not in physical contact with the sample during the preparation or processing of the biological sample;
d. it is contained within a container;
e. it is contained within a device;
f. it is a fragrance selected from the group consisting of linalool, limonene, citral, and citronellol, or a mixture thereof;
g. it comprises a mixture of compounds; and
h. it comprises a mixture of coumarin, citronellol, linalool, and benzyl salicylate.

39. The laboratory vessel of claim 37, wherein the device of characteristic (e) is a membrane that is at least permeable for the malodour counteractant.

40. The laboratory vessel of claim 37, having one or more of the following characteristics:
(a) it is selected from the group consisting of sample storage or sample processing vessels, reaction and collection vessels, Eppendorf tubes, multi-well plates, flasks, Erlenmeyer flasks, spin columns, filter tips and dispenser tips, pipette tips, and tubes;
(b) it comprises a receptacle for receiving the malodour counteractant;
(c) it comprises a receptacle comprising a container comprising a composition comprising a malodour counteractant;
(d) it comprises a receptacle for receiving the malodour counteractant;
(e) it comprises a label that comprises the malodour counteractant; and
(f) it is a vessel suitable for growing cell cultures.

41. The laboratory vessel of claim 40, wherein the malodour counteractant of characteristic (b) is contained in a composition and comprised in a container adapted to fit into said receptacle.

42. The laboratory vessel of claim 40, wherein the malodour counteractant of characteristic (d) is contained in a composition and comprised in a container adapted to fit into said receptacle, wherein said receptacle is arranged such that the malodour counteractant is not in physical contact with a biological sample during the preparation or processing of the biological sample.

43. The laboratory vessel of claim 40, wherein the vessel of characteristic (f) is suitable for growing cell cultures at least in laboratory scale.

44. The laboratory vessel of claim 37, further comprising a biological sample.

45. The laboratory vessel of claim 44, wherein the biological sample is selected from the group consisting of eukaryotic cells, prokaryotic cells, fungi, cell cultures, stool, feces, blood, plasma, serum, body fluids, body excretions, saliva, urine, swabs, tissue, clinical samples, and samples derived therefrom.
